(19) United States
(12) Patent Application Publication
(10) Pub. No.: US 2004/0018852 A1
(43) Pub. Date: Jan. 29, 2004

(54) Method and apparatus for alpahanumeric address book conversions in a wireless personal digital assistant

(76) Inventors: Christine Burke, San Diego, CA (US); Jeff Pritchard, Vista, CA (US); Jason B. Kenagy, San Diego, CA (US); Steve Sprigg, Poway, CA (US)

Correspondence Address: Qualcomm Incorporated, Patents Department, 5775 Morehouse Drive, San Diego, CA, 92121-1714, US

(21) Appl. No.: 10/622,598

(22) Filed: Jul. 18, 2003

Related U.S. Application Data
(63) Continuation of application No. 09/540,068, filed on Mar. 31, 2000.

(51) Int. Cl. H04M 1/00

(52) U.S. Cl. 455/550.1; 455/564

(57) ABSTRACT

A system and method for allowing a wireless communication device for conveniently converting alphanumeric characters into numeric characters for dialing is disclosed. The device may further include a Personal Digital Assistant (PDA) as part of the wireless communication device. The unit accepts input from memory that has been highlighted on the PDA display. Any alphanumeric characters saved in address book phone entries will be automatically converted to phone numeric equivalents when dialed. For example, a stored number of 1-800-2EUDORA is treated as 18002383672 when dialed. The unit accepts input from memory into a Alphanumeric to Numeric Converter where the letters an non integers are converted into numbers to be dialed. The converted number is then passed through an undefined character filter where undefined characters are eliminated. The output is then sent to a display where an optional confirmation step takes place before the wireless communication device dials the intended number.

### RELATED APPLICATIONS

This application is a continuation of U.S. Patent Application No. 09/540,068, filed on Mar. 31, 2000.

### FIELD OF THE INVENTION

The present invention pertains generally to the field of wireless communications, and more specifically to converting alphanumeric characters within an address book in a wireless communication device.

### BACKGROUND

The field of wireless communications has many applications including, e.g., cordless telephones, paging, cellular, wireless local loops, and satellite communication systems. A particularly important application is cellular telephone systems which also include Personal Communications Services (PCS) for mobile subscribers.

Wireless communication devices, such as cellular telephones, are widely used as a replacement for conventional telephone systems. Hereinafter the term cellular will be used to refer to any wireless communication device. In addition to functioning as a replacement for a conventional telephone, wireless communication devices offer the advantage of portability, thus enabling the user to establish a wireless communication link between virtually any two locations on Earth.

In addition to conventional voice communication, wireless communication devices also provide features such as voicemail, voice messaging, and automatic callback notification. Callback notification allows a caller to automatically transmit his telephone number to simplify the process of returning a call. For example, the user of a wireless telephone may place a call (the calling party) that is not received by the intended recipient. A message may be left for the intended recipient (the called party) and include a “callback number,” which corresponds to the caller's mobile identification number. The message recipient may readily establish a communication link with the wireless communication device using the callback number.

Other features, such as three-way calling, are also readily implemented using the conventional communication device. The user of the wireless communication device may establish a first communication link by selecting a stored telephone number from a telephone book storage area within the wireless communication device. When the first communication link is established, the user establishes the second communication link by manually entering a second destination telephone number or by selecting a second destination telephone number from the telephone book storage area.

An additional group of features include directory services. Typical services provide for the storage and dialing of telephone numbers stored in memory as part of a telephone directory. Such telephone numbers are typically associated with a name that is represented by an alphanumeric character string. Traditional directory services fall short in some instances. For example, when entering a telephone number that can be represented by an alphanumeric string, the user often has to translate the alphanumeric string manually into a numeric string when either dialing or entering the number into the telephone directory.. What is needed is a mechanism to provide for the automatic translation and dialing of an alphanumeric string with a minimum of difficulty.

### SUMMARY OF THE INVENTION

The preferred embodiment of the invention is directed to a system and method for allowing a wireless communication device to conveniently for converting alphanumeric characters into numeric characters for dialing. Any alphanumeric characters saved in address book phone entries will be automatically converted to phone numeric equivalents when dialed. For example, a stored number of 1-800-2EUDORA is treated as 18002383672 when dialed. The unit accepts input from memory into a Alphanumeric to Numeric Converter where the letters an non integers are converted into numbers to be dialed. The converted number is then passed through an undefined character filter where undefined characters are eliminated. The output is then sent to a display where an optional confirmation step takes place before the wireless communication device dials the intended number.

The device may further include a Personal Digital Assistant (PDA) as part of the wireless communication device. The unit accepts input from memory that has been highlighted on the PDA display. As in the previous embodiment, the unit accepts input from memory into a Alphanumeric to Numeric Converter where the letters an non integers are converted into numbers to be dialed. The converted number is then passed through an undefined character filter where undefined characters are eliminated. The output is then sent to a display where an optional confirmation step takes place before the wireless communication device dials the intended number.

The invention may also be directed to treating highlighted text as a destination address, such as an e-mail address or as a Uniform Resource Locator used to access an internet site.

Embodiments of the invention will be further described with reference to the following drawings.

### BRIEF DESCRIPTION OF THE DRAWINGS

FIG. 1 illustrates a radiotelephone system in which an embodiment of the current invention operates.

FIG. 2 illustrates a radiotelephone unit in which an embodiment of the current invention operates.

FIG. 3 illustrates in functional block diagram of a specific embodiment of the invention.

FIG. 4 illustrates in flowchart form a method of operation of an embodiment of the present invention.

### DETAILED DESCRIPTION OF THE PREFERRED EMBODIMENT

An illustrative implementation of a microprocessor-based telephone system in accordance with the invention is presented here. The illustration uses an automobile cellular phone as an example, but it will be understood by those skilled in the art that the invention can be implemented in virtually any telecommunications system.

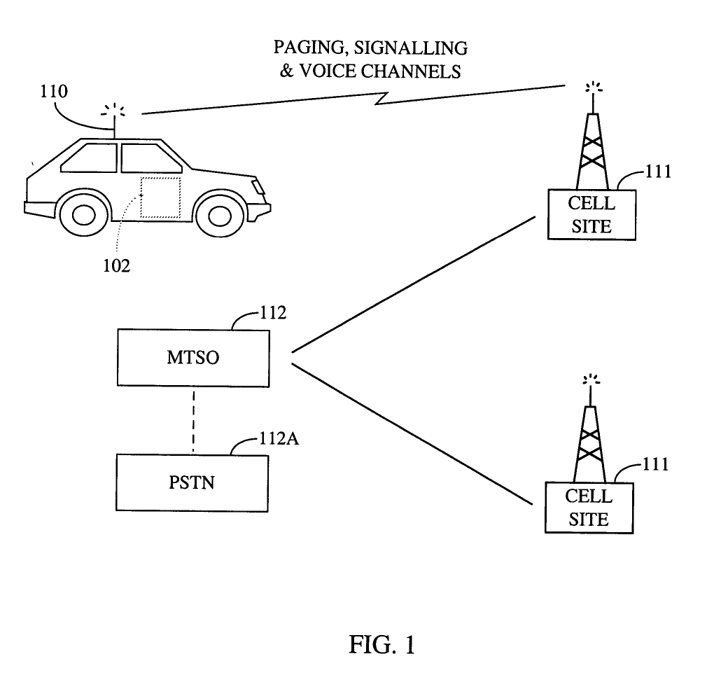

FIG. 1 illustrates a typical wireless radiotelephone system 100 including a mobile station 102 having a unique mobile identification number (MID) stored in a suitable location such as FLASH memory or in an electrically eraseable programmable read-only memory (EEPROM, not shown). Telephone units of this kind are well known in the art and are described here only in sufficient detail to aid understanding the invention. Mobile station 102 communicates with cell site 111 through antenna 110 via paging, signaling and voice/data channels. Cell site 111 (two are illustrated) communicates to Mobile Terminal Switching Office (MTSO) 112 via a radiolink or landline and then to the Public Switched Telephone Network (PSTN) 112A via a high capacity landline or similar connection.

Such mobile stations are typically hand held devices but historically have been associated with an automobile. However, the embodiments described within refer to any wireless device, whether or not handheld, mobile, fixed in location or any combination thereof

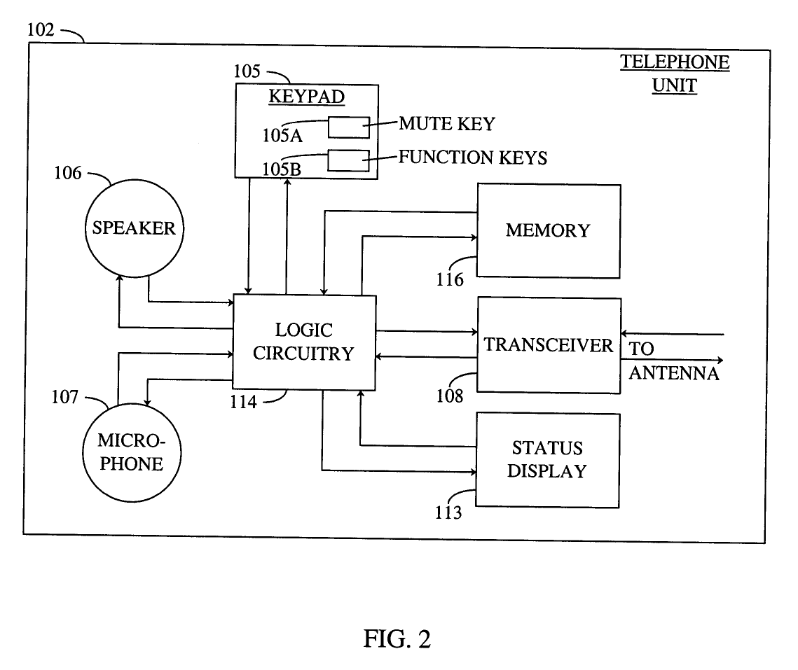

Referring now to FIG. 2, the telephone unit 102 includes a handset 104 having a keypad 105; equivalently, the keypad 105 could be located separately from the handset. Also included in the telephone unit 102 are a speaker 106 and a microphone 107, shown as being mounted within the handset 104 but either or both of which could equivalently be mounted apart from the handset, either separately (e.g., in a telephone operator's headset or in wall mountings), or approximately together (e.g., in a walkie-talkie or speakerphone configuration). It will be apparent to those of ordinary skill that if the keypad 105, the speaker 106, and the microphone 107 are all located apart from the handset 104, the handset can be dispensed with.

Additionally, any reference to a soft key is also intended to be equivalent to a smart key that is programmable to represent a predefined function, a menu selected option from a display screen, a selectable icon or any other type of input.

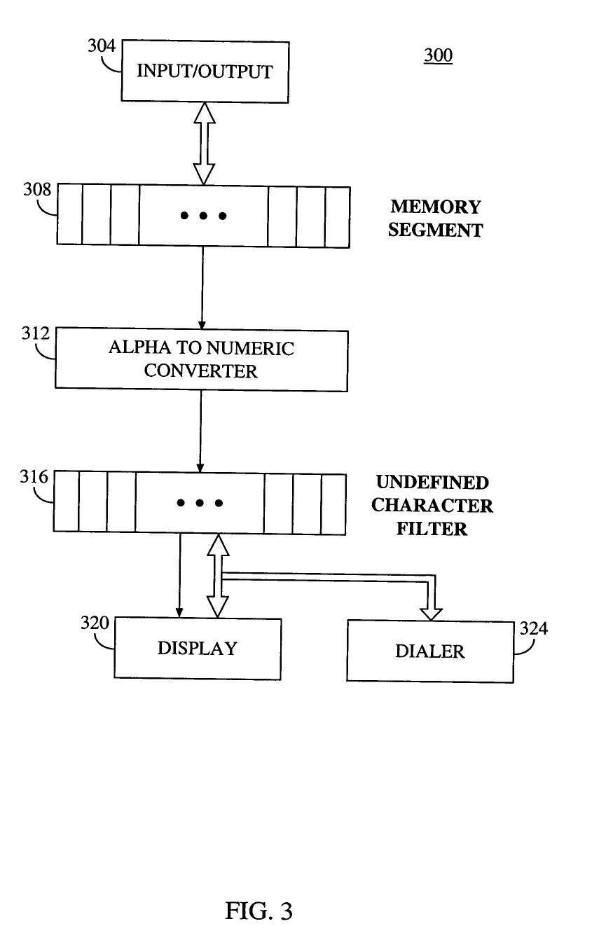

FIG. 3 illustrates a functional block diagram of an embodiment of the instant invention. Apparatus 300 includes a mechanism for converting alphanumeric characters into numeric characters for dialing a telephone device. An optional input/output device 304 is bi-directionally connected with an internal memory segment 308. Internal memory segment 308 containing an input segment string is operationally connected to alphanumeric to numeric converter 312 for translating. Alphanumeric converter 312 is operationally connected to a filter 316 for filtering undefined characters from the translated segment string. The character filter is operably connected to a display 320 for viewing the translated number for dialing and is also connected to a dialer 324 for dialing the translated number. Note that input/output device 304 may contain display 320.

The operation of apparatus 300 will now be discussed in further detail. In one embodiment of the invention, input/output device 304 includes an input touch screen display as found in the QUALCOMM® pdQ™ smartphone, which is now manufactured and sold by Kyocera Wireless Corporation. Background for the pdQ™ may be found at http://www.kyocera-wireless.com/pdq/index.html, as of the date of this filing and is hereby incorporated by reference. Input output 304 also optionally includes a standard touchpad and/or microphone speaker combination for audio input/output. A user selectively inputs alphanumeric characters into wireless apparatus 300 via a user keypad. Such a keypad is similar in nature to the keypad found on a conventional telephone where the alphabet is mapped to a set of numeric keys. For example, A, B and C are mapped to the number 2 on the conventional keypad. D, E and F are mapped to the number 3, and so forth. A string of alphanumeric characters is entered via the keypad or external keyboard. In an embodiment of the invention, any input beyond 32 characters is truncated, such as when a telephone number is to be dialed.

When using the display as found in the QUALCOMM® pdQ™ smartphone, the user selects an alphanumeric text string from the display. The user executes the dialer function by selecting the dialer icon from the display menu. In both the keypad and display cases, the system then begins conversion of the alphanumeric string to numeric string in converter 312.

Note that there are many ways the alphanumeric string may be entered into memory segment 308. The alphanumeric string may be the result of a voice to text conversion, the result of a physical interchange of electrical, infrared or photonic signals from an external detached source or from some other internal or external source. Additionally, the alphanumeric string may be selected from the display by highlighting a portion of a text string found on the display. The portion of text may be part of a written text file or from text or other input retrieved from a browser while connected to an external source. The text may be part of or found within an electronic mail or attachment received or transferred to the wireless device. The text may otherwise be any part of a text or character segment found in the course of using a Personal Digital Assistant (PDA).

The converted string is then passed from converter 312 to character filter 316. Character filter 316 strips out any characters that have not been defined within its parameters. These characters may include but are not limited to the “-” (dash) character conventionally used to separate groups of digits when writing a phone number.

The output of the character filter is then sent to display 320 for viewing and to dialer 324, either simultaneously or in serial after confirmation from the user. In an embodiment of the invention, any output beyond 32 characters is truncated, such as when a telephone number is to be dialed.

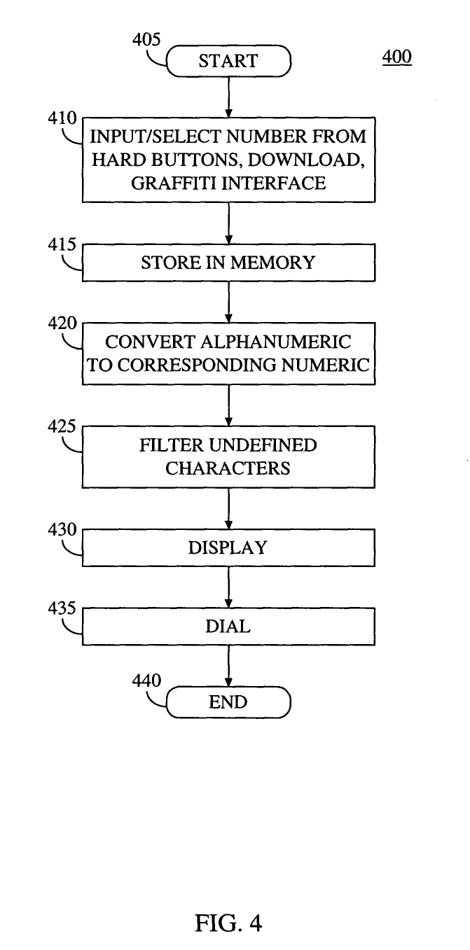

FIG. 4 illustrates in flowchart format the operation 400 of an embodiment of the present invention. The process begins in step 405 labeled START. Flow control transfers to step 410, where a user downloads information into the unit via keys on the face of the unit, through an automatic download or via hand entry via a Graffiti interface. A Graffiti interface uses a stylus for writing in a specialized alphabet on a touch screen. Interface software translates handwritten writings in the specialized alphabet to a format readable by the unit. The entries are then stored in memory in step 415.

In step 420 the Alphanumeric to Numeric converter 312 ignores the appropriate characters and converts the rest to a numeric number for dialing. In step 425, the undefined characters are then stripped off the translated number. The translated number is displayed in step 430, while the number is dialed in step 435 before control is passed to step 440 END.

Data information may be stored in a Personal Information Manager (PIM). Such a PIM may be of the form of a software program resident on a Personal Computer or may take the form of a built in program found in a Personal Digital Assistant (PDA). PIMs and PDAs typically are used as organizational tools and typically contain scheduling and address (contact) information. PIM/PDAs are well known in the art and need not be discussed in further detail here. Such a PIM/PDA may be integral to the phone or may be operationally connected with the phone in a number of ways, including direct physical connection, wireless radio frequency (RF) connection or infrared (IR) connection.

The user's phone may be synchronized with a PIM/PDA either continuously or on a periodic basis. For example, a user will enter his contact directory portions of his/her schedule from the PIM/PDA into the phone.

It is to be understood that even though various embodiments and advantages of the present invention have been set forth in the foregoing description, the above description is illustrative only, and changes may be made in detail, yet remain within the broad principles of the invention. For example, it should be noted that the claimed invention applies to any device that can update a phonebook directory and is not limited to wireless communication devices Therefore, the present invention is to be limited only by the appended claims.

1. A wireless communication device comprising:
a keypad having buttons, wherein the buttons have alphabetical characters mapped to corresponding numeric characters;
a memory configured to store a string of alphanumeric characters representing a telephone number; and
an alphanumeric converter, coupled with the memory, configured to receive the string of alphanumeric characters and to translate the string of alphanumeric characters into corresponding numeric characters.

2. A wireless communication device comprising:
means for mapping alphabetical characters to corresponding numeric characters;
means for storing a string of alphanumeric characters representing a telephone number; and
means for receiving the string of alphanumeric characters and translating the string of alphanumeric characters into corresponding numeric characters.

3. A method comprising:
mapping alphabetical characters to corresponding numeric characters;
storing a string of alphanumeric characters representing a telephone number; and
receiving the string of alphanumeric characters and translating the string of alphanumeric characters into corresponding numeric characters.
